(19) United States
(12) Patent Application Publication
(10) Pub. No.: US 2025/0273387 A1
(43) Pub. Date: Aug. 28, 2025

(54) INDUCTOR AND METHOD FOR MANUFACTURING INDUCTOR

(71) Applicant: Murata Manufacturing Co., Ltd., Kyoto-fu (JP)

(72) Inventor: Noriyuki OOKAWA, Nagaokakyo-shi (JP)

(73) Assignee: Murata Manufacturing Co., Ltd., Kyoto-fu (JP)

(21) Appl. No.: 18/971,603

(22) Filed: Dec. 6, 2024

(30) Foreign Application Priority Data
Feb. 26, 2024 (JP) 2024-026704

(51) Int. Cl. H01F 27/29; H01F 3/08; H01F 5/04; H01F 27/02; H01F 41/10

(52) U.S. Cl. CPC H01F 27/292; H01F 3/08; H01F 5/04; H01F 27/022; H01F 41/10

(57) ABSTRACT

An inductor includes a coil conductor including a pair of extended portions; an element body containing a metallic magnetic particle and a first resin and enclosing the coil conductor; an outer electrode connected to one of the extended portions exposed from a surface of the element body; and an element body protective film including an opening at a portion where at least the extended portion is exposed from the surface of the element body, and covering the surface of the element body. The outer electrode includes a first plated layer on the extended portion and a second plated layer on the first plated layer, the first and second plated layers are extended while covering a rim portion of the opening of the element body protective film, and respective end portions of the first plated layer and the second plated layer are in contact with the element body protective film.

### CROSS-REFERENCE TO RELATED APPLICATION

This application claims benefit of priority to Japanese Patent Application No. 2024-026704, filed Feb. 26, 2024, the entire content of which is incorporated herein by reference.

### BACKGROUND

### Technical Field

The present disclosure relates to an inductor and a method for manufacturing an inductor.

### Background Art

International Publication No. WO2017/135058 discloses an inductor which includes a coil conductor provided with a pair of extended portions, an element body including metallic magnetic particles and a resin and enclosing the coil conductor, an element body protective film covering a surface of the element body, and a pair of outer electrodes electrically connected to the extended portions exposed from the element body protective film. In this inductor, the outer electrodes may be formed in such a way as to run on part of the element body protective film.

When the outer electrodes are provided in such a way as to run on part of the element body protective film, portions of the outer electrodes running on the element body protective film rise and an external form of the inductor is therefore increased. As a consequence, dimensions of the element body are adjusted smaller in order to keep the inductor within restrictions of its external dimensions, thus leading to deterioration of electrical characteristics as the inductor.

### SUMMARY

Accordingly, the present disclosure realizes favorable electrical characteristics of an inductor by forming an outer electrode in such a way as to run on a rim portion of an element body protective film so as to improve environment resistance while suppressing the occurrence of restrictions in external dimensions of an element body due to a rise of the outer electrode that runs thereon.

An aspect of the present disclosure is an inductor including a coil conductor including a pair of extended portions; an element body containing a metallic magnetic particle and a first resin and enclosing the coil conductor; an outer electrode connected to one of the extended portions exposed from a surface of the element body; and an element body protective film including an opening at a portion where at least the extended portion is exposed from the surface of the element body, and covering the surface of the element body. The outer electrode includes a first plated layer formed on the extended portion and a second plated layer formed on the first plated layer. The first plated layer and the second plated layer are extended while covering a rim portion of the opening of the element body protective film, and respective end portions of the first plated layer and the second plated layer are in contact with the element body protective film. Also, an average film thickness of the element body protective film in a range where the element body protective film is in contact with the end portion of the first plated layer is smaller than an average film thickness of the element body protective film in a range where the element body protective film is in contact with the end portion of the second plated layer.

Another aspect of the present disclosure is a method for manufacturing an inductor including a coil conductor forming step of fabricating a coil conductor including a pair of extended portions; an element body molding step of embedding the coil conductor in an element body, which contains a metallic magnetic particle and a first resin, such that one of the extended portions of the coil conductor is exposed from a surface of the element body; an element body protective film forming step of providing the surface of the element body with an element body protective film that covers the surface of the element body; a surface treating step of removing the element body protective film at a planned electrode location out of the surface of the element body, the planned electrode location including an exposed portion of the extended portion exposed from the element body; and an outer electrode forming step of forming an outer electrode by plating on the exposed portion of the extended portion and on the surface of the element body at the planned electrode location. The element body protective film is removed such that a thickness of a rim portion of the removed element body protective film becomes gradually thinner toward inside of the planned electrode location in the surface treating step. Also, a copper plated layer is formed to reach a range that covers the rim portion of the element body protective film formed in such a way as to have a gradually thinned thickness, and a nickel plated layer is formed on the copper plated layer in the outer electrode forming step.

According to the present disclosure, it is possible to realize favorable electrical characteristics of an inductor by forming an outer electrode in such a way as to run on a rim portion of an element body protective film so as to improve environment resistance while suppressing the occurrence of restrictions in external dimensions of an element body due to a rise of the outer electrode that runs thereon.

### BRIEF DESCRIPTION OF THE DRAWINGS

FIG. 1 is a perspective view of an inductor according to an embodiment of the present disclosure, which is viewed from an upper surface side;

FIG. 2 is a perspective view of the inductor which is viewed from a bottom surface side;

FIG. 3 is a see-through perspective view illustrating an internal constitution of the inductor;

FIG. 4 is a see-through plan view of the inductor illustrated in FIG. 3, which is viewed from the upper surface side;

FIG. 5 is a cross-sectional view of the inductor taken along the V-V line in FIG. 4;

FIG. 6 is a partial detail drawing of a portion A on the cross-section illustrated in FIG. 5;

FIG. 7 is a diagram illustrating an example of an element mapping image in an EDX analysis on a portion B illustrated in FIG. 6;

FIG. 8 is a diagram illustrating a manufacturing process of the inductor; and

FIG. 9 is a diagram for explaining element body molding.

### DETAILED DESCRIPTION

An embodiment of the present disclosure will be described below with reference to the drawings.

### 1. Constitution of Inductor

First, a constitution of an inductor 1 according to the present embodiment will be described.

### 1.1 Overall Constitution of Inductor

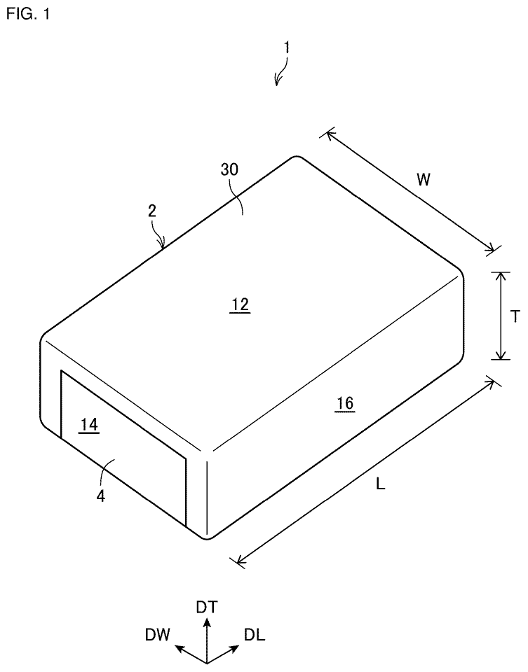

FIGS. 1 to 3 are diagrams illustrating an overall constitution of the inductor 1.

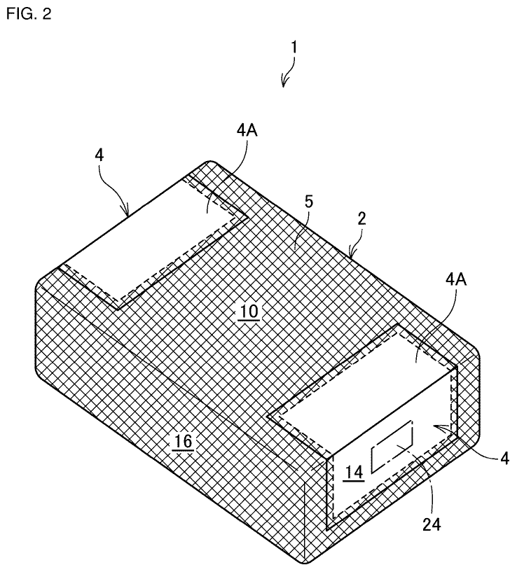

FIG. 1 is a perspective view of the inductor 1 viewed from an upper surface 12 side, and FIG. 2 is a perspective view of the inductor 1 viewed from a bottom surface 10 side.

The inductor 1 of the present embodiment is constructed as a surface-mounted electronic component, which includes an element body 2 having a substantially rectangular parallelepiped shape that represents an aspect of a substantially hexahedral shape, and a pair of outer electrodes 4 provided on a surface of the element body 2.

In the following, a first principal surface of the element body 2 oriented to a not-illustrated mounting substrate at the time of mounting will be defined as the bottom surface 10, a second principal surface thereof facing the bottom surface 10 will be referred to as the upper surface 12, a pair of third principal surfaces located orthogonal to the bottom surface 10 will be referred to as end surfaces 14, and a pair of fourth principal surfaces located orthogonal to the bottom surface 10 and the pair of end surfaces 14 will be referred to as side surfaces 16.

As illustrated in FIG. 1, a distance from the bottom surface 10 to the upper surface 12 will be defined as a thickness T of the element body 2, a distance between the pair of side surfaces 16 will be defined as a width W of the element body 2, and a distance between the pair of end surfaces 14 will be defined as a length L of the element body 2. Meanwhile, a direction of the thickness T will be defined as a thickness direction DT, a direction of the width W will be defined as a width direction DW, and a direction of the length L will be defined as a length direction DL.

As for a size of the inductor, a length L dimension is equal to 2.0 mm, a width W dimension is equal to 1.2 mm, and a thickness T dimension is equal to 0.9 mm, for example.

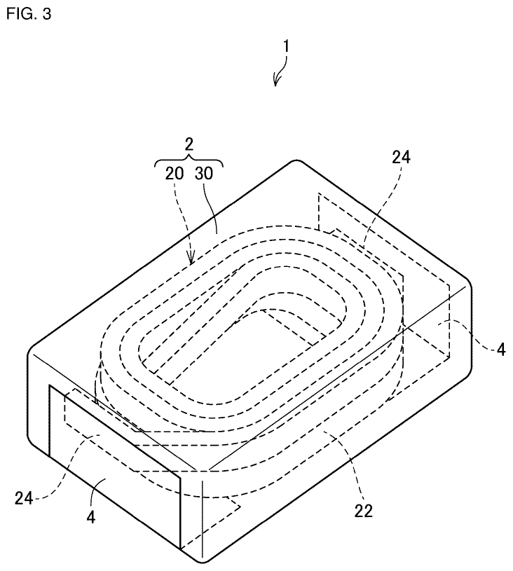

FIG. 3 is a see-through perspective view illustrating an internal constitution of the inductor.

The element body 2 includes a coil conductor 20 and a substantially hexahedral shaped core 30 in which the coil conductor 20 is embedded. The element body 2 is constructed as a mold inductor that encapsulates the coil conductor 20 in the core 30.

The core 30 is a pressure-molded compact formed by pressurizing and heating mixed powder, which is obtained by mixing metallic magnetic particles 30a and a first resin 30b, into the substantially hexahedral shape in a state of encapsulating the coil conductor 20.

The mixed powder may include a solvent or a curing agent. The mixed powder may further include an additive such as a lubricant.

The metallic magnetic particles 30a of the present embodiment include particles having two types of grain sizes, namely, first magnetic particles being large particles having a relatively large average grain size and second magnetic particles being small particles having a relatively small average grain size. Accordingly, the second magnetic particles being the small particles as well as the resin penetrate into gaps between the first magnetic particles being the large particles at the time of pressure molding. Thus, it is possible to increase a filling rate of the metallic magnetic particles 30a in the core 30, and to improve magnetic permeability as well.

In the present embodiment, D50 grain sizes (median diameters) of the metallic particles of the first magnetic particles and the second magnetic particles are set to 28 μm and 4.0 μm, respectively. Here, the D50 grain size of the first magnetic particles is preferably in a range from equal to or above 10 μm and equal to or below 50 μm (i.e., from 10 μm to 50 μm), while the D50 grain size of the second magnetic particles is preferably in a range from equal to or above 1 μm and equal to or below 5 μm (i.e., from 1 μm to 5 μm). Meanwhile, the magnetic particles may further include particles having a different average grain size from those of the first magnetic particles and the second magnetic particles, thus including the particles having three or more types of the grain sizes.

The first magnetic particles and the second magnetic particles are particles including metallic particles and insulating films covering surfaces thereof. The metallic particles covered with insulating films improve insulation resistance and voltage resistance.

For example, Fe-based metallic magnetic particles such as Fe (pure iron) or a Fe alloy are used as the metallic particles of the first magnetic particles and the second magnetic particles. As an example of the Fe alloy, it is possible to use one or more alloys selected from the group consisting of an alloy including Fe and Ni, an alloy including Fe and Co, an alloy including Fe and Si, an alloy including Fe, Si, and Cr, an alloy including Fe, Si, and Al, an alloy including Fe, Si, B, and Cr, and an alloy including Fe, P, Cr, Si, B, Nb, and C.

A composition of the metallic particles of the first magnetic particles and a composition of the metallic particles of the second magnetic particles may be the same as or different from each other.

The insulating films to be formed on the surfaces of the metallic particles of the first magnetic particles and the second magnetic particles can be one or more insulating coatings selected from the group consisting of an inorganic glass coating, an organic-inorganic hybrid coating, and an inorganic insulating coating formed by a sol-gel reaction of a metal alkoxide, for example.

In the present embodiment, Fe—Si—Cr amorphous alloy powder is used as the metallic particles of the first magnetic particles, and the Fe—Si—Cr amorphous alloy powder is used as the metallic particles of the second magnetic particles.

In the mixed powder, at least one selected from the group consisting of epoxy resin, phenol resin, polyester resin, polyimide resin, polyolefin resin, and silicone resin can be used as a material of the first resin 30b. Among them, a magnetic compact having a high electrical insulation property and a high mechanical strength can be obtained when epoxy resin is used as the resin. Besides the aforementioned materials, a thermoplastic resin such as polyamideimide, polyphenylenesulfide, and/or a liquid crystal polymer may be used as the resin material. A curing reaction is preferably a thermal reaction. In other words, the resin is preferably a thermosetting resin. Thermosetting epoxy resin is cited as an example thereof. It is possible to bring about the curing reaction with a simple method by using the above-mentioned resin.

A solvent for obtaining a slurry by mixing the metallic magnetic particles 30a with the first resin 30b can be added to the mixed powder. The solvent is preferably an organic solvent. For example, the solvent may include any of an aromatic hydrocarbon such as toluene and xylene; a ketone such as acetone, methyl ethyl ketone, and a methyl isobutyl ketone; an alcohol such as methanol, ethanol, and isopropyl alcohol; and a glycol ether such as propylene glycol monomethyl ether and propylene glycol monomethyl ether acetate.

A curing agent for curing the first resin 30b may be added to the mixed powder. For example, the curing agent may include any of an imidazole-based curing agent, an amine-based curing agent, and a guanidine-based curing agent (such as dicyandiamide).

A lubricant may be added to the mixed powder in order to improve lubricity of the first magnetic particles and the second magnetic particles and to improve filling rates thereof. The lubricant can also be added for the purpose of facilitating release from a mold at the time of molding. For example, the lubricant may include any of nanosilica, barium sulfate, and a stearic acid compound (such as lithium stearate, magnesium stearate, zinc stearate, and potassium stearate).

Meanwhile, as for ratios by weight of the respective raw materials included in the mixed powder, the first magnetic particle and the second magnetic particle may account for equal to or above 94 percent by weight and equal to or below 98 percent by weight (i.e., from 94 percent by weight to 98 percent by weight) of the total, the first resin 30b and the curing agent may account for equal to or above 1 percent by weight and equal to or below 5 percent by weight (i.e., from 1 percent by weight to 5 percent by weight) of the total, and the lubricant and the solvent may account for the rest. As for a proportion of first magnetic raw material particles to second magnetic raw material particles, a proportion of a weight of the first magnetic raw material particles to a weight of the second magnetic raw material particles is preferably set equal to or above 10:90 and equal to or below 50:50 (i.e., from 10:90 to 50:50). As for a proportion of the first resin 30b to the curing agent, a proportion of a weight of the first resin 30b to a weight of the curing agent is preferably set equal to or above 95:5 and equal to or below 98:2 (i.e., from 95:5 to 98:2).

As illustrated in FIG. 3, the coil conductor 20 includes a wound portion 22 where a conductive wire is wound, and a pair of extended portions 24 extended from the wound portion 22 and at least partially exposed from the element body 2.

The coil conductor 20 is formed from the conductive wire and a covering layer formed on a surface of the conductive wire. The conductive wire is a band-like conductive wire (a so-called flat rectangular conductive wire) made of copper and having a rectangular cross-section.

Note that the coil conductor 20 does not always have to be wound, and may have a linear shape, a meandering shape, and the like instead.

The wound portion 22 of the coil conductor 20 is formed by, for example, extending both ends of the band-like conductive wire (hereinafter also simply referred to as the conductive wire) to an outer periphery, and spirally winding the conductive wire such that the portions thereof are joined to each other on an inner periphery. Inside the element body 2, the coil conductor 20 is embedded in the core 30 in such a posture that a center axis of the wound portion 22 is aligned with the thickness direction DT of the element body 2. The extended portions 24 are extended from the wound portion 22 to the pair of end surfaces 14, and one of principal surfaces of each extended portion 24 is exposed from the element body 2 while the other principal surface thereof is embedded in the element body 2.

An element body protective film 5 being an insulating film that covers the surface of the element body 2 is formed on the surface of the element body 2. The element body protective film 5 includes a second resin 51 and an inorganic filler 52. For example, the second resin 51 may be any of epoxy, urethane, acryl, polyimide, polyimideamide, and polyamide. Meanwhile, a material of the inorganic filler 52 may be any of titanium oxide, silicon dioxide, alumina, and calcium carbonate, for example. In the meantime, a shape of the inorganic filler may be any appropriate shape such as a scale-like shape, a flat shape, a spherical shape, an elliptical shape, and a wire-like shape.

As illustrated in FIG. 2, the element body protective film 5 (a portion provided with hatching in FIG. 2) has openings at portions where at least the extended portions 24 are exposed. In the present embodiment, the openings of the element body protective film 5 spread from the respective end surfaces 14 of the element body 2 toward the bottom surface 10 in conformity with the shapes of the outer electrodes 4 to be described below.

The pair of outer electrodes 4 are so-called L-shaped electrodes that extend from the respective end surfaces 14 of the element body 2 toward the bottom surface 10 and are configured with L-shaped members. Each outer electrode 4 is connected to the extended portion 24 of the coil conductor 20 at the end surface 14, and a portion 4A (FIG. 2) extending to the bottom surface 10 is electrically connected to wiring of a circuit board by using an appropriate mounting tool such as solder.

In the present embodiment, the outer electrode 4 is formed in such a way as to cover a rim portion of the opening of the element body protective film 5 and to run on the element body protective film 5. Since the outer electrode 4 covers the rim portion of the element body protective film 5 and runs thereon, a length of a boundary surface between the outer electrode 4 and the element body protective film 5 is increased. Accordingly, moisture intrusion from the boundary surface to the surface of the element body 2 is suppressed, for example, and environment resistance of the inductor 1 may be improved.

The inductor having the above-described constitution can improve direct-current superimposition characteristics by using a soft magnetic material for the magnetic particles, and is therefore used as an electronic component of an electrical circuit that carries a large current, and as a choke coil for a DC-DC converter circuit or a power supply circuit. Meanwhile, this inductor is also used as an electronic component of electronic equipment such as a personal computer, a DVD player, a digital camera, a television set, a cellular phone, a smartphone, a car electronic appliance, and medical or industrial machinery. However, use applications of the inductor are not limited to the foregoing. For example, the inductor can also be used for a tuned circuit, a filter circuit, a rectifying and smoothing circuit, and the like.

### 1.2 Constitution of Opening Rim Portion of Element Body Protective Film

Next, a constitution of the rim portion of the opening of the element body protective film 5 will further be described. As mentioned above, the outer electrode 4 is formed at the rim portion of the opening of the element body protective film 5 in such a way as to run thereon.

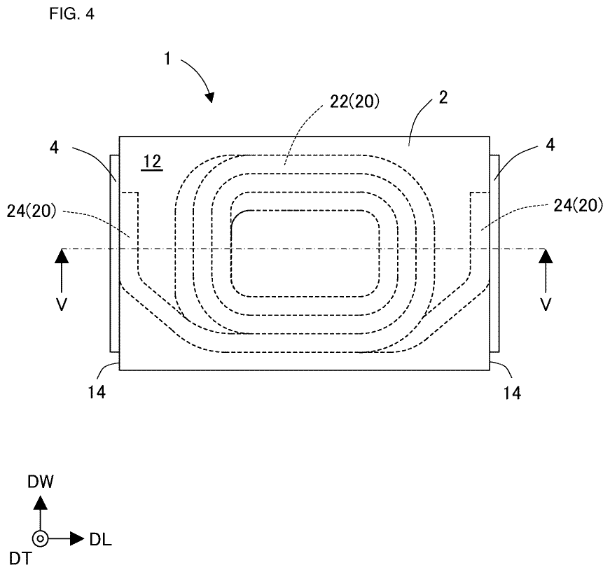

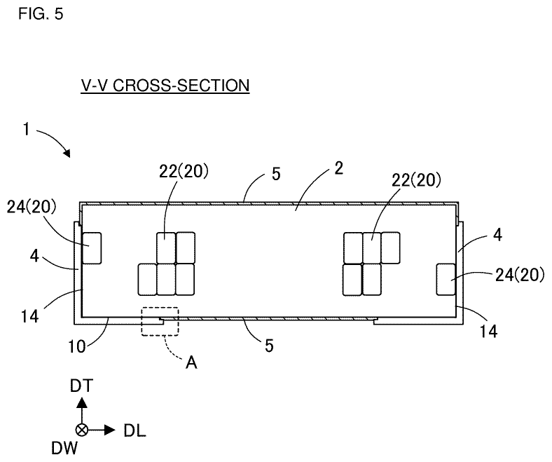

FIG. 4 is a see-through plan view of the inductor 1 illustrated in FIGS. 1 and 3, which is viewed from the upper surface 12 side, and FIG. 5 is a cross-sectional view of the inductor 1 taken along the V-V line and viewed along arrows illustrated in FIG. 4.

As illustrated in FIG. 5, the two extended portions 24 of the coil conductor 20 are exposed from right and left end surfaces 14 in FIG. 5. The element body protective film 5 (the portion illustrated with hatching) that covers the surface of the element body 2 has the openings at the respective portions of the extended portions 24 exposed from the right and left end surfaces 14, and the respective openings (the portions of the surface of the element body 2 without the element body protective film 5 illustrated with hatching in FIG. 5) spread from the respective end surfaces 14 on the right and left toward the bottom surface 10. Moreover, the right and left outer electrodes 4 illustrated in FIG. 5 cover the rim portions of the openings of the element body protective film 5 and run on the element body protective film 5.

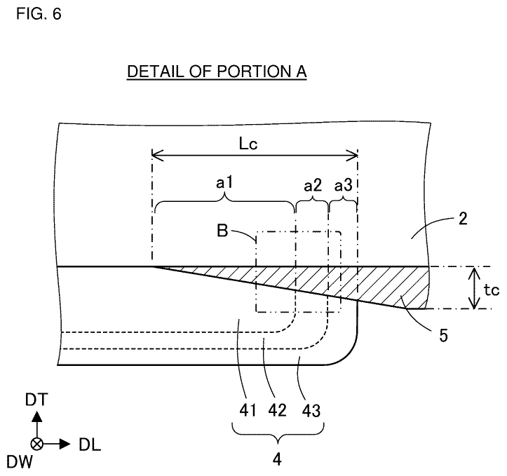

FIG. 6 is a partial detail drawing of a portion A illustrated in FIG. 5. The portion A illustrated in FIG. 5 is a portion where the outer electrode 4 on the left side in FIG. 5 covers the rim portion of the opening of the element body protective film 5 and runs on the element body protective film 5 at the bottom surface 10.

In FIG. 6, the outer electrode 4 includes a first plated layer 41 formed on the surface of the element body 2, and a second plated layer 42 formed on the first plated layer 41. As described above, the outer electrode 4 extends from the end surface 14 toward the bottom surface 10. Accordingly, the first plated layer 41 is formed on the extended portion 24 at the end surface 14.

The outer electrode 4 may also include a third plated layer 43 formed on the second plated layer 42. In the present embodiment, the first plated layer 41 and the second plated layer 42 are a copper plated layer and a nickel plated layer, respectively. The third plated layer 43 may be a tin plated layer, for example.

The first plated layer 41, the second plated layer 42, and the third plated layer 43 constituting the outer electrode 4 cover the rim portion of the element body protective film 5 and extend on the element body protective film 5. Respective end portions of the first plated layer 41, the second plated layer 42, and the third plated layer 43 are in contact with the element body protective film 5 at a right portion in FIG. 6.

Moreover, an average film thickness tc1 of the element body protective film 5 in a range a1 where the element body protective film 5 is in contact with the end portion of the first plated layer 41 is smaller than an average film thickness tc2 of the element body protective film 5 in a range a2 where the element body protective film 5 is in contact with the end portion of the second plated layer 42.

Accordingly, at the rim portion of the opening of the element body protective film 5, the thickness of the element body protective film 5 is formed gradually smaller toward the opening. Thus, a height of a rise of the outer electrode 4 that runs on the rim portion of the opening of the element body protective film 5 is suppressed to a low level. As a consequence, it is possible to improve environment resistance by forming the outer electrode 4 in such a way as to run on the rim portion of the element body protective film 5 while suppressing the occurrence of restrictions in external dimensions of the element body 2 due to the rise of the outer electrode 4 that runs thereon, thereby realizing favorable electrical characteristics.

When the outer electrode 4 includes the third plated layer 43 formed on the second plated layer 42 as in the present embodiment, the element body protective film 5 may further be configured such that the average film thickness tc2 of the element body protective film 5 in the range a2 where the element body protective film 5 is in contact with the end portion of the second plated layer 42 is smaller than an average film thickness tc3 of the element body protective film 5 in a range a3 where the element body protective film 5 is in contact with the end portion of the third plated layer 43.

Accordingly, even when the outer electrode 4 is constructed as a three-layered structure, it is possible to improve environment resistance and to suppress the occurrence of restrictions in external dimensions of the element body 2 due to the rise of the outer electrode 4 on the rim portion of the element body protective film 5, thereby realizing favorable electrical characteristics.

As illustrated in FIG. 6, in the present embodiment, the thickness of the rim portion of the element body protective film 5 is formed gradually thinner toward the opening (in other words, formed gradually thinner from the right to the left in FIG. 6). Accordingly, the inductor 1 is formed such that the average film thicknesses tc3, tc2, and tc1 of the element body protective film 5 at the portions in contact with the third plated layer 43, the second plated layer 42, and the first plated layer 41 mentioned above, respectively, are thinner in this order.

In this way, the rise of the outer electrode 4 that runs on the rim portion of the opening of the element body protective film 5 can be effectively suppressed.

Here, the rim portion of the element body protective film 5 is formed in such a way as to change its thickness linearly in the example of FIG. 6. Instead, the element body protective film 5 may be formed in such a way as to change its thickness non-linearly by providing a curved portion, steps, and the like.

For example, an average thickness of the first plated layer 41 is equal to or above 3 μm and equal to or below 30 μm (i.e., from 3 μm to 30 μm), while an average thickness of both the second plated layer 42 and the third plated layer 43 is equal to 3 μm. Meanwhile, in FIG. 6, a run-on length Lc representing a length for which the outer electrode 4 runs on from the rim portion of the element body protective film 5 is equal to or above 10 μm and equal to or below 100 μm (i.e., from 10 μm to 100 μm), for example. Here, when the first plated layer 41 and the second plated layer 42 are formed from the copper plated layer and the nickel plated layer, respectively, the adhesion of the outer electrode 4 with the element body 2 can be improved by forming the average thickness of the nickel plated layer, which is prone to retain a tensile stress within the layer, smaller than the average thickness of the copper plated layer.

### Method for Evaluating Average Film Thicknesses Tc1, Tc2, and Tc3

The average film thicknesses tc1, tc2, and tc3 of the element body protective film 5 in the ranges a1, a2, and a3 with which the first plated layer 41, the second plated layer 42, and the third plated layer 43 are in contact, respectively, can be measured as described below.

First, the side surface 16 of the element body 2 of the fabricated inductor 1 is polished in the DW direction (see FIG. 1), thereby obtaining a cross-section including the DT direction and the DL direction (hereinafter referred to as an LT cross-section) along a center line in the DW direction, for example. The LT cross-section at a central portion in the DW direction of the inductor 1 obtained by the polishing may be subjected to an ion milling process, for example. Next, a portion of the obtained LT cross-section corresponding to the portion A in FIG. 5 is subjected to element analysis mapping regarding an area of a field of view having dimensions equal to or above 75 μm×56 μm and equal to or below 100 μm×75 μm (i.e., from 75 μm×56 μm to 100 μm×75 μm) corresponding to the range illustrated in FIG. 6 in accordance with an energy dispersive X-ray analysis (EDX analysis) by using a field emission scanning electron microscope (FE-SEM). Thus, an element mapping image in the vicinity of the rim portion of the opening of the element body protective film 5 at the portion corresponding to the portion A is obtained.

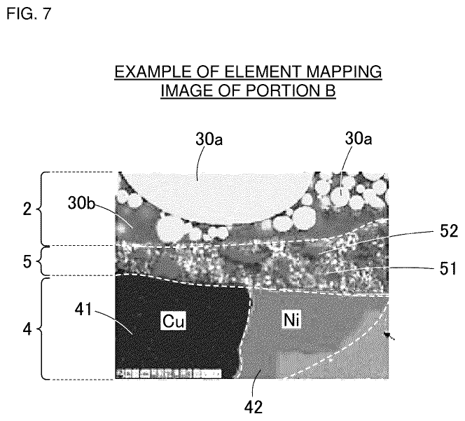

FIG. 7 is a diagram illustrating an example of the element mapping image, obtained as described above, in the vicinity of the rim portion of the opening of the element body protective film 5 at a portion corresponding to the portion B in FIG. 6. The element mapping image illustrated in FIG. 7 includes the element body 2, the element body protective film 5, the first plated layer 41 being the copper plated layer, and the second plated layer 42 being the nickel plated layer. In FIG. 7, large and small spheres inside the element body 2 represent the metallic magnetic particles 30a and a portion filling spaces between the spheres represents the first resin 30b. The inorganic filler 52 and the second resin 51 filling spaces between particles of the inorganic filler 52 are observed inside the element body protective film 5.

Next, the thickness of the element body protective film 5 in a range of the run-on length Lc illustrated in FIG. 6 is measured at intervals of 1 μm in a direction of a boundary line between the element body 2 and the element body protective film 5 (the DL direction indicated in FIG. 6) by using the element mapping image obtained as described above. Then, average values of thickness measurement values of the element body protective film 5 measured at the intervals of 1 μm regarding the range a1 where the first plated layer 41 runs on the element body protective film 5, the range a2 where the end portion of the second plated layer 42 is in contact with the element body protective film 5, and the range a3 where the end portion of the third plated layer 43 is in contact with the element body protective film 5. Then, the average values are evaluated as the average film thicknesses tc1, tc2, and tc3 of the element body protective film 5 in the ranges a1, a2, and a3 with which the first plated layer 41, the second plated layer 42, and the third plated layer 43 are in contact, respectively.

The above-described average film thicknesses tc1, tc2, and tc3 may be measured not only on the LT cross-section along the center line in the DW direction, but may also be measured on LT cross-sections at one or more appropriate positions (such as three positions at W/4, W/2, and 3 W/4 from the side surface (three cross-sections)) in the DW direction from one of the side surfaces 16. The average film thicknesses tc1, tc2, and tc3 have been obtained regarding these cross-sections, and the respective cross-sections have been confirmed to satisfy conditions defined in the appended claims.

### 1.3 Preferred Constitutions of Element Body Protective Film and Element Body

Next, preferred constitutions of the element body protective film 5 and the element body 2 will be described.

### 1.3.1 Film Constitution of Element Body Protective Film

The element body protective film 5 preferably includes the second resin 51 as mentioned above. Accordingly, flexibility of the element body protective film 5 is improved by flexibility that the resins have in general, so that damage such as breakage of the element body protective film 5 can be suppressed even when a stress is applied to the inductor 1. Meanwhile, since the element body protective film 5 includes the second resin, even when the copper plated layer is formed as a portion of the outer electrode 4, it is possible to realize the element body protective film 5 that is hardly dissolved in a copper plating solution.

Meanwhile, an average grain size measured in terms of an equivalent circle diameter of the inorganic filler 52 included in the element body protective film 5 is preferably equal to or below 10 μm.

Accordingly, when the stress is applied to the inductor 1, minute cracks develop around the inorganic filler 52 having the small average grain size, whereby application of the stress to the element body 2 is suppressed. Thus, the occurrence of fatal defects such as breakage of the element body 2 can be effectively prevented. Here, the average grain size of the inorganic filler 52 is preferably equal to or above 1 nm.

Here, the respective average grain sizes of the metallic magnetic particles 30a and the inorganic filler 52 do not always have to be the average grain sizes in light of the entire element body 2 and the entire element body protective film 5. Instead, the average grain sizes may be average grain sizes in light of respective portions of the element body 2 and the element body protective film 5. From the viewpoint of the aforementioned stress relaxation in particular, the average grain size of the inorganic filler 52 at the rim portion of the element body protective film 5 where the outer electrode 4 runs on is preferably smaller than the average grain size of the metallic magnetic particles 30a at the portion of the element body 2 in contact with the rim portion of the element body protective film 5.

In the meantime, magnitude comparison of the average grain sizes between the metallic magnetic particles 30a and the inorganic filler 52 can be carried out by, for example, using average values of the respective equivalent circle diameters of the metallic magnetic particles 30a and the inorganic filler 52 in the image as the average grain sizes.

Comparative evaluation method of sizes of metallic magnetic particles and inorganic filler

To be more precise, the comparison of the sizes between the metallic magnetic particles and the inorganic filler can be carried out as follows.

First, the side surface 16 of the element body 2 of each of the multiple (three, for example) inductors 1 fabricated in the same production lot is polished in the DW direction (see FIG. 1), thereby obtaining the LT cross-section along the center line in the DW direction, for example. The LT cross-section at the central portion in the DW direction of each inductor 1 obtained by the polishing may be subjected to the ion milling process, for example. Next, any appropriate portion in the obtained LT cross-section including the boundary between the element body 2 and the element body protective film 5 is subjected to the element analysis mapping regarding the area of the field of view having the dimensions equal to or above 75 μm×56 μm and equal to or below 100 μm×75 μm (i.e., from 75 μm×56 μm to 100 μm×75 μm). In the mapping image thus obtained, the individual equivalent circle diameters of the metallic magnetic particles 30a and particles of the inorganic filler 52 shot in the mapping image are obtained. In this instance, regarding the metallic magnetic particles 30a and the particles of the inorganic filler 52 among the individual metallic magnetic particles 30a and the particles of the inorganic filler 52 which are only partially shot at ends of the mapping image, the equivalent circle diameters thereof may be obtained by supplementarily obtaining more mapping images with shifted fields of view.

An overall average value of the individual equivalent circle diameters of the metallic magnetic particles 30a obtained from the respective inductors 1 is defined as the average grain size of the metallic magnetic particles 30a, and an overall average value of the individual equivalent circle diameters of the particles of the inorganic filler 52 obtained likewise is defined as the average grain size of the inorganic filler 52.

Then, the average grain size of the metallic magnetic particles 30a and the average grain size of the inorganic filler 52 thus obtained are compared with each other.

For example, in the present embodiment, the average grain size of the first magnetic particles is in a range from equal to or above 20 μm and equal to or below 60 μm (i.e., from 20 μm to 60 μm), and the average grain size of the inorganic filler 52 at the rim portion of the element body protective film 5 is in a range from equal to or above 0.01 μm and equal to or below 10 μm (i.e., from 0.01 μm to 10 μm).

### 1.3.2 Layout of Element Body Protective Film on Surface of Element Body

As illustrated in FIG. 6, the element body protective film 5 is preferably not provided between the surface of the element body 2 and the first plated layer 41 except for a portion where the first plated layer 41 of the outer electrode 4 covers the rim portion of the element body protective film 5 (that is to say, the rim portion of the element body protective film 5 where the outer electrode 4 runs thereon).

Accordingly, it is possible to prevent the element body protective film 5 from being formed at an unnecessary portion on the surface of the element body 2 and causing a rise on the surface of the outer electrode 4, thereby avoiding the occurrence of restrictions in external dimensions of the element body 2.

### 1.3.3 Constitution of Element Body

A content ratio of the first resin 30b at a portion of a superficial layer (hereinafter referred to as a superficial layer portion) of the element body 2 is preferably larger than a content ratio of the first resin 30b at a portion other than the superficial layer (hereinafter referred to as a non-superficial layer portion) thereof.

Accordingly, the inductor 1 can keep favorable inductance characteristics while maintaining a high density of the metallic magnetic particles 30a at the non-superficial layer portion of the element body 2, and improve voltage resistance performances as the inductor 1 by setting a resistivity at the superficial layer portion of the element body 2 to be provided with the outer electrodes 4 higher than that at the non-superficial layer portion.

Here, the superficial layer of the element body 2 means, for example, a layered range from the surface of the element body 2 to a depth at a predetermined distance into the element body 2. The predetermined distance is set to 25 μm, for example.

As described later, the content ratio of the first resin 30b at the superficial layer portion of the element body 2 can be adjusted in an element body molding step (S2) in a manufacturing process of the inductor 1 by using a clearance between an aperture of a cavity 65 and an external form of a punch 66 used for pressure molding, for example.

Comparative evaluation method of contents of first resin at superficial layer portion and non-superficial layer portion of element body

Comparative evaluation of the content ratio of the first resin 30b at the superficial layer portion of the element body 2 and the content ratio of the first resin 30b at the non-superficial layer portion thereof can be carried out as described below.

First, the side surface 16 of the element body 2 of the fabricated inductor 1 is polished in the DW direction (see FIG. 1), thereby obtaining the LT cross-section at a position of W/4 from the side surface 16. The LT cross-section obtained by the polishing may be subjected to the ion milling process, for example. Next, the obtained LT cross-section is subjected to the element analysis mapping regarding the area of the field of view having the dimensions equal to or above 75 μm×56 μm and equal to or below 100 μm×75 μm (i.e., from 75 μm×56 μm to 100 μm×75 μm).

Assuming that the surface of the element body 2 has a depth equal to 0 μm, a depth range equal to or above 0 μm and below 25 μm (i.e., from 0 μm to below 25 μm) to the inside of the element body 2 will be defined as a range of the superficial layer. An element quantitative analysis is carried out on the above-described superficial layer range across the entire width of the field of view of the EDX image. A content ratio (in the unit of atom %, for example) of carbon in the above-mentioned range obtained as a result of the analysis will be defined as an evaluation amount that represents the content ratio of the first resin 30b in the superficial layer portion of the element body 2.

Meanwhile, assuming that the surface of the element body 2 has the depth equal to 0 μm, a depth range equal to or above 25 μm and equal to or below 50 μm (i.e., from 25 μm to 50 μm) to the inside of the element body 2 will be defined as a range of the non-superficial layer. An element quantitative analysis is carried out on the above-described non-superficial layer range across the entire width of the field of view of the EDX image. A content ratio of carbon in the above-mentioned range obtained as a result of the analysis will be defined as an evaluation amount that represents the content ratio of the first resin 30b in the non-superficial layer portion of the element body 2.

The LT cross-section of the element body 2 subjected to the above-described analyses is further polished in the DW direction (see FIG. 1), thereby obtaining the LT cross-section at a position of W/2 from the side surface 16. Concerning the LT cross-section at the position of W/2 thus obtained, an evaluation amount of the content ratio of the first resin 30b in the superficial layer portion and an evaluation amount of the content ratio of the first resin 30b in the non-superficial layer portion are obtained as with the above-described procedures.

Likewise, concerning the LT cross-section at a position of 3 W/4 from the side surface 16, an evaluation amount of the content ratio of the first resin 30b in the superficial layer portion and an evaluation amount of the content ratio of the first resin 30b in the non-superficial layer portion are obtained.

Then, the fact that the evaluation amount of the content ratio of the first resin 30b in the superficial layer portion is larger than the evaluation amount of the content ratio of the first resin 30b in the non-superficial layer portion is confirmed regarding each of the three LT cross-sections at the positions of W/4, W/2, and 3 W/4 from the side surface 16.

From the viewpoint of the voltage resistance performance of the inductor 1, the evaluation amount of the content ratio of the first resin 30b in the superficial layer portion is preferably larger by 5 atom % or more than the evaluation amount of the content ratio of the first resin 30b in the non-superficial layer portion (that is to say, the content ratio of carbon in the superficial layer portion is preferably larger by 5 atom % or more than the content ratio of carbon in the non-superficial layer portion).

### 2. Manufacturing Process of Inductor

The inductor 1 may be fabricated as described below.

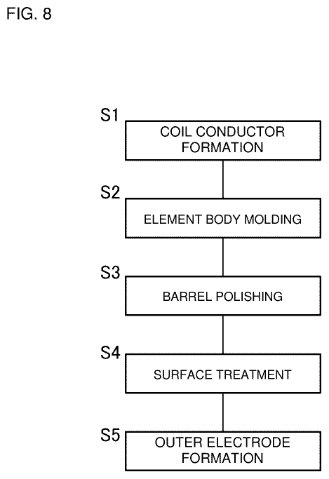

FIG. 8 is a diagram illustrating a manufacturing process of the inductor 1.

The manufacturing process of the inductor 1 may include a coil conductor forming step (S1), an element body molding step (S2), a barrel polishing step (S3), a surface treating step (S4), and an outer electrode forming step (S5).

The coil conductor forming step (S1) is a step of forming the coil conductor 20 from the conductive wire. In this step, the coil conductor 20 is formed into a shape provided with the above-described wound portion 22 and the pair of extended portions 24 by winding the conductive wire in a winding mode referred to as “alpha winding”. The alpha winding represents a state where the conductive wire functioning as the conductor is spirally wound in two stages such that the extended portions 24 at a winding start and a winding end are located on an outer periphery. The number of turns of the coil conductor 20 is not limited to a particular number. As mentioned above, it is to be noted that the coil conductor 20 does not always have to be wound, and may have a linear shape, a meandering shape, and the like instead.

In the element body molding step (S2), tablets (solids having predetermined shapes) are formed by preliminarily molding the above-described mixed powder, and the tablets and the coil conductor 20 are disposed in a cavity of a molding die. Subsequently, the tablets and the coil conductor 20 are pressurized by using the punch while heating the cavity. Thus, the element body 2 is fabricated by pressure-molding the tablets.

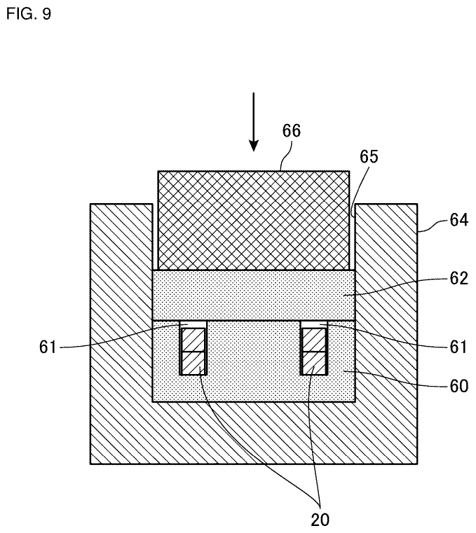

As illustrated in FIG. 9, two types of tablets, namely, a first tablet 60 having an appropriate shape (such as an E-shape) provided with a groove 61 into which the coil conductor 20 enters, and a second tablet 62 having an appropriate shape (such as an I-shape and a plate-like type) to cover the groove 61 of the first tablet 60 are used as the preliminarily molded tablets. At the time of pressure molding, the first tablet 60 including the coil conductor 20 fitted into the groove 61, and the second tablet 62 are disposed in a superposed fashion into a cavity 65 of a molding die 64. Then, the first tablet 60, the coil conductor 20, and the second tablet 62 are integrated together by heating the first tablet 60 and the second tablet 62 and applying pressure with the punch 66 from the first tablet 60 side and/or the second tablet 62 side (from the second tablet 62 side in the example of FIG. 9) in a direction of this superposition. As for conditions of the above-described pressure molding, for example, a temperature of the cavity 65 is set to 180° C., and a pressure force and pressurizing time by the punch 66 are set to 20 MPa and 600 seconds, respectively.

Here, the first resin 30b located inside the element body 2 can be moved toward the superficial layer of the element body 2 at the time of the above-described pressure molding by adjusting the clearance between the aperture of the cavity 65 of the molding die 64 and the external form of the punch 66, which are used for the pressure molding, to a value larger than such a value that establishes an engaged state of the cavity 65 with the punch 66. Accordingly, the content ratio of the first resin 30b in the superficial layer portion of the element body 2 after the pressure molding can be made larger than the content ratio of the first resin 30b in the non-superficial layer portion thereof.

In the barrel polishing step (S3), the multiple element bodies 2 are put into a drum, and the drum is rotated in such a way as not to apply an excessively strong impact thereto. Meanwhile, a coating liquid to be formed into the element body protective film 5 is sprayed thereon. Accordingly, corner portions of the element bodies 2 are rounded and the coating liquid is applied onto the element bodies 2. In the present embodiment, the coating liquid includes a silicon dioxide filler to be formed into the inorganic filler 52, and epoxy resin to be formed into the second resin 51.

Next, the element bodies 2 to which the coating liquid is applied are taken out of the drum and are subjected to a thermal treatment. Thus, the element body protective film 5 is formed on the surface of each element body 2.

Note that formation of the element body protective film 5 is not limited to the above-described method. The element body protective film 5 can be formed by providing a different step from the barrel polishing step (S3), and by carrying out various methods including spraying the coating liquid on the element body 2, dipping the element body 2 in the coating liquid, supplying the coating liquid to the surface of the element body 2 by using a dispenser, and/or applying the coating material on the surface of the element body 2 in accordance with various printing modes.

The surface treating step (S4) is a step of reforming a surface at a planned electrode location of the core 30 by irradiating the surface at the planned electrode location with a laser beam. Here, the planned electrode location represents a range on the surface of the core 30 where the outer electrode 4 is supposed to be formed, which includes a portion where the extended portion 24 is exposed. To be more precise, the element body protective film 5 on the surface of the core 30 and the covering layer on the extended portion 24 of the coil conductor 20 are removed by scanning the range at the planned electrode location with the laser beam. Moreover, the first resin 30b on the surface of the core 30 is removed and the insulating films on the surfaces of the metallic magnetic particles 30a exposed from the core 30 are also removed. Accordingly, at a portion of the planned electrode location out of the surface of the core 30, an area of exposure of the metal in the metallic magnetic particles 30a per unit area on the surface of the core 30 becomes larger than that at the remaining portion of the surface of the core 30. Meanwhile, as a consequence of removal of the element body protective film 5 at the planned electrode location out of the surface of the element body 2, the element body protective film 5 is provided with the opening at the planned electrode location on the surface of the element body 2.

A wavelength of the laser beam is, for example, equal to or above 180 nm and equal to or below 3000 nm (i.e., from 180 nm to 3000 nm), or more preferably equal to or above 532 nm and equal to or below 1064 nm (i.e., from 532 nm to 1064 nm). Meanwhile, irradiation energy of the laser beam is preferably equal to or above 1 W/mm² and equal to or below 30 W/mm² (i.e., from 1 W/mm² to 30 W/mm²), or more preferably equal to or above 5 W/mm² and equal to or below 12 W/mm² (i.e., from 5 W/mm² to 12 W/mm²).

In the present embodiment, the element body protective film 5 is removed at the planned electrode location, in particular, such that the thickness of the rim portion of the removed element body protective film 5 becomes gradually thinner toward the inside of the planned electrode location. The above-mentioned adjustment of the change in thickness at the rim portion of the element body protective film 5 can be carried out, for example, by modulating an irradiation intensity of the laser beam when the planned electrode location is scanned with the laser beam. To be more precise, the thickness at the rim portion of the element body protective film 5 can be gradually thinned toward the planned electrode location by gradually reducing an intensity of a spot of the laser beam that moves toward an outer side portion of the planned electrode location at an outer rim portion of the planned electrode location (a position corresponding to the rim portion of the opening of the element body protective film 5).

Here, the adjustment of the change in thickness at the rim portion of the element body protective film 5 is not limited to the above-mentioned modulation of the irradiation intensity of the laser beam, but may also be carried out by using any appropriate method. For example, assuming that the element body protective film 5 at the planned electrode location is removed by blasting, the element body protective film 5 may be formed into such a shape that the thickness at the rim portion of the element body protective film 5 is gradually thinned toward the planned electrode location by adjusting a blast spraying pressure at the outer rim portion of the planned electrode location.

In the outer electrode forming step (S5), the outer electrode 4 is formed at the planned electrode location on the core 30. To be more precise, the copper (Cu) plated layer serving as the first plated layer 41 is formed by electrolytic plating at the planned electrode location on the core 30. Subsequently, the nickel (Ni) plated layer and the tin (Sn) plated layer serving as the second plated layer 42 and the third plated layer 43 may be formed on the first plated layer 41 by electrolytic plating.

For example, copper sulfate plating, copper pyrophosphate plating, and copper cyanide plating can be used for forming the copper plated layer.

An additive such as a brightening agent may be added to plating solutions at the time of forming the Ni plated layer and the Sn plated layer.

In the present embodiment, the copper plated layer serving as the first plated layer 41 is formed to reach a range that covers the rim portion of the element body protective film 5 which is formed to have the gradually thinned thickness, and the nickel plated layer serving as the second plated layer 42 is formed on the copper plated layer in the outer electrode forming step (S5) in particular. The formation of the copper plated layer that covers the rim portion of the element body protective film 5 can be achieved by causing the copper plated layer formed at the planned electrode location to grow toward the surface at the rim portion of the element body protective film 5 by performing adjustment to prolong plating processing time in the course of the above-described formation of the copper plated layer, for example.

### 3. Other Embodiments

The first plated layer 41 of the outer electrode 4 may be formed in such a way as to come into direct contact with the extended portion 24, or another conductive layer may be included between the first plated layer 41 and the extended portion 24. Inclusion of the other layer makes it possible to improve, for example, an adhesion strength between the extended portion 24 and the outer electrode 4.

For example, one or more conductive layers formed by applying resin silver and/or resin copper, and/or one or more metallic layers formed by sputtering and the like may be provided between the first plated layer 41 and the extended portion 24. A material of the above-mentioned metallic layer may be, for example, a single metal of any of platinum (Pt), gold (Au), aluminum (Al), copper (Cu), nickel (Ni), lead (Pd), and chromium (Cr) or an alloy of two or more metals selected from the aforementioned metals.

Meanwhile, except for the portion where the outer electrode 4 covers the rim portion and element body protective film 5 and is extended onto the element body protective film 5, the first plated layer 41 of the outer electrode 4 may come into direct contact with the surface of the element body 2, or another layer as with the aforementioned layer may be provided between the first plated layer 41 and the surface of the element body 2.

In the meantime, the respective end portions of the first plated layer 41, the second plated layer 42, and the third plated layer 43 are brought into direct contact with the element body protective film 5 in the above-described embodiment. Instead, the end portions may be bought into indirect contact with the element body protective film 5 with another layer interposed therebetween, which is formed on the element body protective film 5. In this case, the above-described average film thicknesses tc1, tc2, and tc3 of the element body protective film 5 may be defined as average film thicknesses of the element body protective film 5 in the ranges a1, a2, and a3 in indirect contact with the first plated layer 41, the second plated layer 42, and the third plated layer 43, respectively, with the other layer interposed therebetween.

In the above-described embodiment, the metallic magnetic particles 30a included in the element body 2 are formed from the two types of magnetic particles having the different average grain sizes. Instead, the metallic magnetic particles 30a may be formed from one type of magnetic particles or three or more types of magnetic particles having different average grain sizes.

It is to be noted that all of the embodiments and examples described above merely exemplify certain aspects of the present disclosure, which can be arbitrarily modified or applied within the range not departing from the gist of the present disclosure.

Meanwhile, the directions including the horizontal and perpendicular directions and the like as well as various numerical values, shapes, and materials discussed in the above-described embodiments include ranges (so-called equivalent ranges) having the same operations and effects as those of the directions, the numerical values, the shapes, and the materials mentioned above unless otherwise specifically stated.

### 4. Constitutions Supported by Embodiments and Examples Described Above

The embodiments and the examples described above support the following constitutions.

(Constitution 1) An inductor includes: a coil conductor including a pair of extended portions; an element body containing a metallic magnetic particle and a first resin and enclosing the coil conductor; an outer electrode connected to one of the extended portions exposed from a surface of the element body; and an element body protective film including an opening at a portion where at least the extended portion is exposed from the surface of the element body, and covering the surface of the element body. The outer electrode includes a first plated layer formed on the extended portion and a second plated layer formed on the first plated layer. The first plated layer and the second plated layer are extended while covering a rim portion of the opening of the element body protective film, and respective end portions of the first plated layer and the second plated layer are in contact with the element body protective film. Also, an average film thickness of the element body protective film in a range where the element body protective film is in contact with the end portion of the first plated layer is smaller than an average film thickness of the element body protective film in a range where the element body protective film is in contact with the end portion of the second plated layer.

According to the inductor of Constitution 1, at the rim portion of the opening of the element body protective film, the thickness of the element body protective film is formed gradually smaller toward the opening. Thus, the height of the rise of the outer electrode that runs on the rim portion of the opening of the element body protective film is suppressed to a low level. As a consequence, it is possible to improve environment resistance by forming the outer electrode in such a way as to run on the rim portion of the element body protective film while suppressing the occurrence of restrictions in external dimensions of the element body due to the rise of the outer electrode that runs thereon, thereby realizing favorable electrical characteristics.

(Constitution 2) The inductor according to Constitution 1, in which the first plated layer is a copper plated layer, and the second plated layer is a nickel plated layer.

According to the inductor of Constitution 2, the copper plated layer which is made of the same metal as the copper wire being generally used as the coil conductor and has high electrical conductivity is used as the first plated layer located closest to the extended portion extended from the coil conductor, and the nickel plated layer having a high anticorrosion property is used as the second plated layer. Thus, it is possible to realize favorable direct-current resistance characteristics and environment resistance while securing a favorable adhesion of the outer electrode with the element body.

(Constitution 3) The inductor according to Constitution 1 or 2, in which the outer electrode further includes a third plated layer formed on the second plated layer, the third plated layer covers the rim portion of the element body protective film in cooperation with the first plated layer and the second plated layer, and an end portion of the third plated layer is in contact with the element body protective film, and the average film thickness of the element body protective film in the range where the element body protective film is in contact with the end portion of the second plated layer is smaller than an average film thickness of the element body protective film in a range where the element body protective film is in contact with the end portion of the third plated layer.

According to the inductor of Constitution 3, even in the case of using the outer electrode having the three-layered structure, it is possible to improve environment resistance and to suppress the occurrence of restrictions in external dimensions of the element body due to a rise of the outer electrode on the rim portion of the element body protective film, thereby realizing favorable electrical characteristics.

(Constitution 4) The inductor according to Constitution 3, in which the third plated layer is a tin plated layer.

According to the inductor of Constitution 4, the third plated layer is made of tin having high solder wettability. This makes it easier to mount the inductor on a mounting substrate.

(Constitution 5) The inductor according to any one of Constitutions 1 to 4, in which the element body protective film contains a second resin.

According to the inductor of Constitution 5, flexibility of the element body protective film is improved by flexibility that resins have in general, so that damage such as breakage of the element body protective film can be suppressed even when a stress is applied to the inductor. Moreover, even when forming the copper plated layer as a portion of the outer electrode, it is possible to realize the element body protective film that is hardly dissolved in a copper plating solution.

(Constitution 6) The inductor according any one of Constitutions 1 to 5, in which the element body protective film contains an inorganic filler of which an average grain size measured in terms of an equivalent circle diameter is equal to or below 10 μm.

According to the inductor of Constitution 6, when a stress is applied to the inductor, minute cracks develop around the inorganic filler having the small average grain size whereby application of the stress to the element body 2 is suppressed. Thus, the occurrence of fatal defects such as breakage of the element body 2 can be effectively prevented.

(Constitution 7) The inductor according to any one of Constitutions 1 to 6, in which a thickness of the element body protective film at the rim portion is formed gradually smaller toward the opening.

According to the inductor of Constitution 7, the rise of the outer electrode that runs on the rim portion of the opening of the element body protective film can be effectively suppressed.

(Constitution 8) The inductor according to any one of Constitutions 1 to 7, in which a content ratio of the first resin at a superficial layer of the element body that contains the metallic magnetic particle and the first resin is larger than a content ratio of the first resin at a portion other than the superficial layer of the element body.

According to the inductor of Constitution 8, it is further possible to keep favorable inductance characteristics while maintaining a high density of the metallic magnetic particles at the non-superficial layer portion of the element body, and to improve voltage resistance performances as the inductor by increasing the content ratio of the first resin at the superficial layer portion of the element body to be provided with the outer electrode so as to increase the resistivity of the superficial layer portion.

(Constitution 9) The inductor according to any one of Constitutions 1 to 8, in which the element body protective film is not provided between the surface of the element body and the first plated layer except for a portion where the first plated layer covers the rim portion of the element body protective film.

According to the inductor of Constitution 9, it is possible to prevent the element body protective film from being formed at an unnecessary portion on the surface of the element body and causing a rise on the surface of the outer electrode, thereby avoiding the occurrence of restrictions in external dimensions of the element body.

(Constitution 10) A method for manufacturing an inductor includes: a coil conductor forming step of fabricating a coil conductor including a pair of extended portions; an element body molding step of embedding the coil conductor in an element body, which contains a metallic magnetic particle and a first resin, such that one of the extended portions of the coil conductor is exposed from a surface of the element body; an element body protective film forming step of providing the surface of the element body with an element body protective film that covers the surface of the element body; a surface treating step of removing the element body protective film at a planned electrode location out of the surface of the element body, the planned electrode location including an exposed portion of the extended portion exposed from the element body; and an outer electrode forming step of forming an outer electrode by plating on the exposed portion of the extended portion and on the surface of the element body at the planned electrode location. The element body protective film is removed such that a thickness of a rim portion of the removed element body protective film becomes gradually thinner toward inside of the planned electrode location in the surface treating step. Also, a copper plated layer is formed to reach a range that covers the rim portion of the element body protective film formed in such a way as to have a gradually thinned thickness, and a nickel plated layer is formed on the copper plated layer in the outer electrode forming step.

According to the method for manufacturing an inductor of Constitution 10, it is possible to manufacture the inductor that can realize favorable electrical characteristics by improving environment resistance by forming the outer electrode in such a way as to run on the rim portion of the element body protective film while suppressing the occurrence of restrictions in external dimensions of the element body due to the rise of the outer electrode that runs thereon.

What is claimed is:

1. An inductor comprising:
a coil conductor including a pair of extended portions;
an element body including a metallic magnetic particle and a first resin and enclosing the coil conductor;
an outer electrode connected to one of the extended portions exposed from a surface of the element body; and
an element body protective film including an opening at a portion where at least the extended portion is exposed from the surface of the element body, and covering the surface of the element body, wherein
the outer electrode includes a first plated layer on the extended portion and a second plated layer on the first plated layer,
the first plated layer and the second plated layer are extended while covering a rim portion of the opening of the element body protective film, and respective end portions of the first plated layer and the second plated layer are in contact with the element body protective film, and
an average film thickness of the element body protective film in a range where the element body protective film is in contact with the end portion of the first plated layer is smaller than an average film thickness of the element body protective film in a range where the element body protective film is in contact with the end portion of the second plated layer.

2. The inductor according to claim 1, wherein
the first plated layer is a copper plated layer, and
the second plated layer is a nickel plated layer.

3. The inductor according to claim 1, wherein
the outer electrode further includes a third plated layer on the second plated layer,
the third plated layer covers the rim portion of the element body protective film in cooperation with the first plated layer and the second plated layer, and an end portion of the third plated layer is in contact with the element body protective film, and
the average film thickness of the element body protective film in the range where the element body protective film is in contact with the end portion of the second plated layer is smaller than an average film thickness of the element body protective film in a range where the element body protective film is in contact with the end portion of the third plated layer.

4. The inductor according to claim 3, wherein the third plated layer is a tin plated layer.

5. The inductor according to claim 1, wherein the element body protective film includes a second resin.

6. The inductor according to claim 1, wherein
the element body protective film includes an inorganic filler of which an average grain size measured in terms of an equivalent circle diameter is equal to or below 10 μm.

7. The inductor according to claim 1, wherein
a thickness of the element body protective film at the rim portion is gradually smaller toward the opening.

8. The inductor according to claim 1, wherein
a content ratio of the first resin at a superficial layer of the element body that includes the metallic magnetic particle and the first resin is larger than a content ratio of the first resin at a portion other than the superficial layer of the element body.

9. The inductor according to claim 1, wherein
the element body protective film is absent from between the surface of the element body and the first plated layer except for a portion where the first plated layer covers the rim portion of the element body protective film.

10. The inductor according to claim 2, wherein
the element body protective film is absent from between the surface of the element body and the first plated layer except for a portion where the first plated layer covers the rim portion of the element body protective film.

11. The inductor according to claim 3, wherein
the element body protective film is absent from between the surface of the element body and the first plated layer except for a portion where the first plated layer covers the rim portion of the element body protective film.

12. The inductor according to claim 4, wherein
the element body protective film is absent from between the surface of the element body and the first plated layer except for a portion where the first plated layer covers the rim portion of the element body protective film.

13. The inductor according to claim 5, wherein
the element body protective film is absent from between the surface of the element body and the first plated layer except for a portion where the first plated layer covers the rim portion of the element body protective film.

14. The inductor according to claim 6, wherein
the element body protective film is absent from between the surface of the element body and the first plated layer except for a portion where the first plated layer covers the rim portion of the element body protective film.

15. The inductor according to claim 7, wherein
the element body protective film is absent from between the surface of the element body and the first plated layer except for a portion where the first plated layer covers the rim portion of the element body protective film.

16. The inductor according to claim 8, wherein
the element body protective film is absent from between the surface of the element body and the first plated layer except for a portion where the first plated layer covers the rim portion of the element body protective film.

17. A method for manufacturing an inductor comprising:
fabricating a coil conductor including a pair of extended portions;
embedding the coil conductor in an element body, which includes a metallic magnetic particle and a first resin, such that one of the extended portions of the coil conductor is exposed from a surface of the element body;
providing the surface of the element body with an element body protective film that covers the surface of the element body;
removing the element body protective film at a planned electrode location out of the surface of the element body, the planned electrode location including an exposed portion of the extended portion exposed from the element body, and the element body protective film is removed such that a thickness of a rim portion of the removed element body protective film becomes gradually thinner toward inside of the planned electrode location; and
forming an outer electrode by plating on the exposed portion of the extended portion and on the surface of the element body at the planned electrode location, such that a copper plated layer is formed to reach a range that covers the rim portion of the element body protective film formed in such a way as to have a gradually thinned thickness, and a nickel plated layer is formed on the copper plated layer.
